(19) United States
(12) Patent Application Publication
(10) Pub. No.: US 2024/0217802 A1
(43) Pub. Date: Jul. 4, 2024

(54) BEVERAGE DISPENSE SYSTEMS WITH AUTOMATIC MIXING

(71) Applicant: PepsiCo, Inc., Purchase, NY (US)

(72) Inventors: Gurmeet Singh BHUTANI, Gurgaon Haryana (IN); Rahul Sadashiv KAMBLE, Faridabad Haryana (IN); Amandeep Singh GULATI, New Delhi (IN)

(21) Appl. No.: 18/148,035

(22) Filed: Dec. 29, 2022

(51) Int. Cl. B67D 1/00; B67D 1/04; B67D 1/08; B67D 1/12

(52) U.S. Cl. CPC B67D 1/0018; B67D 1/0051; B67D 1/0071; B67D 1/0406; B67D 1/0857; B67D 1/1252; B67D 1/1281; B67D 1/0081; B67D 2001/0092; B67D 2001/0093; B67D 2001/0098; B67D 2210/00044

(57) ABSTRACT

A beverage dispense system configured to automatically mix a beverage in response to a user input. The beverage dispense system including a liquid container, a gas container, a regulator, a flavoring container, and a beverage container selectively in fluid communication with the liquid container, the gas container, and the flavoring container that is configured to mix liquid, gas, and flavoring respectively from the liquid container, gas container, and flavoring container into the beverage. The beverage dispense system further including a controller that is configured to automatically control flow of the liquid, the gas, and the flavoring to the beverage container in response to the user input and an outlet configured to selectively dispense the beverage. The regulator is configured to regulate the gas from the gas container to each of the liquid container, the flavoring container, and the beverage container at the pressure.

### FIELD

Embodiments described herein generally relate to beverage dispensing. Specifically, embodiments described herein relate to beverage dispense systems with automatic mixing.

### BACKGROUND

Beverages may be offered to consumers from, for example, retail refrigerators or beverage dispense systems. Retail refrigerators can be deployed in a wide variety of settings, but can encourage wasteful packaging of containers. Some beverage dispense systems include sophisticated machinery with resource demands that inhibit the application of the beverage dispense systems in some environments.

### BRIEF SUMMARY OF THE INVENTION

Some embodiments described herein relate to a beverage dispense system configured to automatically mix a beverage in response to a user input. The beverage dispense system comprising a liquid container configured to contain a liquid and a gas container configured to contain a gas; a regulator connected to an opening of the gas container that is configured to regulate flow of the gas from the gas container such that the gas is supplied from the regulator at a pressure. The beverage dispense system further comprising a flavoring container configured to contain a flavoring and a beverage container selectively in fluid communication with the liquid container, the gas container, and the flavoring container that is configured to receive the liquid, gas, and flavoring respectively from the liquid container, gas container, and flavoring container. The beverage dispense system further comprising a controller that is configured to automatically control flow of the liquid, the gas, and the flavoring to the beverage container in response to the user input to mix the liquid, gas, and flavoring into the beverage and an outlet configured to selectively dispense the beverage. The regulator is connected to each of the liquid container, the flavoring container, and the beverage container and is configured to regulate the gas from the gas container to each of the liquid container, the flavoring container, and the beverage container at the pressure.

Some embodiments described herein relate to a beverage dispense system configured to automatically mix a beverage in response to a user input. The beverage dispense system comprising a liquid container configured to contain a liquid; a gas container configured to contain a gas; a flavoring container configured to contain a flavoring; and a beverage container selectively in fluid communication with the liquid container, the gas container, and the flavoring container that is configured to receive the liquid, gas, and flavoring respectively from the liquid container, gas container, and flavoring container. The beverage dispense system further comprising a controller that is configured to automatically control flow of the liquid, the gas, and the flavoring to the beverage container in response to the user input to mix the liquid, gas, and flavoring into the beverage. The beverage dispense system also comprising an outlet configured to selectively dispense the beverage and a cooler interposed between and the liquid container and the beverage container. The cooler comprises a passive heat sink that does not directly consume power and that is configured to cool the liquid that flows from the liquid container to the beverage container to a temperature.

Some embodiments described herein relate to a beverage dispense system configured to automatically mix a beverage in response to a user input. The beverage dispense system comprising a liquid container configured to contain a liquid; a gas container configured to contain a gas; a flavoring container configured to contain a flavoring; and a beverage container selectively in fluid communication with the liquid container, the gas container, and the flavoring container that is configured to receive the liquid, gas, and flavoring respectively from the liquid container, gas container, and flavoring container. The beverage dispense system further comprising a first valve interposed between the fluid container and the beverage container that is configured to selectively control flow of the liquid from the fluid container to the beverage container; a second valve interposed between the gas container and the beverage container that is configured to selectively control flow of the gas from the gas container to the beverage container; a third valve interposed between the flavoring container and the beverage container that is configured to selectively control flow of the flavoring from the flavoring container to the beverage container; and an outlet configured to selectively dispense the beverage. The beverage dispense system further comprising a controller operatively connected to the first, second, and third valves. The controller comprising a computer having a non-transitory computer readable medium comprising instructions that are executed by the computer in response to the user input to cause the computer to open and close the first, second, and third valves to automatically mix the beverage in the beverage container. The beverage container comprises a transparent material that allows a user to observe mixing of the liquid, gas, and flavoring into the beverage.

Some embodiments herein relate to a beverage dispense system configured to automatically mix a beverage in response to a user input. The beverage dispense system includes a liquid container configured to contain a liquid; a gas container configured to contain a gas; a flavoring container configured to contain a flavoring; a beverage container selectively in fluid communication with the liquid container and the gas container, the beverage container being configured to receive the liquid and gas respectively from the liquid container and gas container; and an outlet fluidly connected to the beverage container and the flavoring container, the outlet configured to selectively dispense the beverage. The beverage dispense system also includes a first valve interposed between the fluid container and the beverage container that is configured to selectively control flow of the liquid from the fluid container to the beverage container; a second valve interposed between the gas container and the beverage container that is configured to selectively control flow of the gas from the gas container to the beverage container; a third valve interposed between the flavoring container and the outlet that is configured to selectively control flow of the flavoring from the flavoring container to the outlet; and a controller operatively connected to the first, second, and third valves. The controller includes a computer having a non-transitory computer readable medium comprising instructions that are executed by the computer in response to the user input to cause the computer to open and close the first, second, and third valves to automatically mix the liquid and gas in the beverage container and to automatically dispense the mix of the liquid and gas and the flavoring through the outlet. The beverage container comprises a transparent material that allows a user to observe mixing of the liquid and gas in the beverage container.

### BRIEF DESCRIPTION OF THE DRAWINGS

The accompanying drawings, which are incorporated herein and form a part of the specification, illustrate the present disclosure and, together with the description, further serve to explain the principles thereof and to enable a person skilled in the pertinent art to make and use the same.

FIG. 1 shows schematic view of an example beverage dispense system.

FIG. 2 shows a front perspective view of the example beverage dispense system.

FIG. 3 shows a rear perspective view of the example beverage dispense system.

FIG. 4 shows a top perspective view of the example beverage dispense system.

FIG. 5 shows a front perspective view of an example beverage dispense system.

FIG. 6 shows schematic view of an example beverage dispense system

FIG. 7 shows a first step of an example automatic beverage mixing process using the example beverage dispense system.

FIG. 8 shows a second step of the example automatic beverage mixing process using the example beverage dispense system.

FIG. 9 shows a third step of the example automatic beverage mixing process using the example beverage dispense system.

FIG. 10 shows a fourth step of the example automatic beverage mixing process using the example beverage dispense system.

FIG. 11 shows a fifth step of the example automatic beverage mixing process using the example beverage dispense system.

FIG. 12 shows a schematic view of an example computer of the example beverage dispense system.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the claims.

Beverages can be offered to consumers in a number of ways. For example, retail refrigerators (e.g., vending machines) can offer chilled, premixed beverages in bottles. Retail refrigerators are advantageous because, for example, they can be economically deployed in diverse retail settings, such as kiosks, small shops, large stores, etc., to reach a large number of consumers. Further, the beverages are high quality since the ingredients and production can be controlled by the beverage producer. But manufacturing bottles for retail refrigerators consumes materials, such as plastic and metals, which can be wasteful. Further, retail refrigerators can include active cooling that can be energy intensive, which can be costly and can inhibit the use of retail refrigerators in localities with unreliable and/or unaffordable power.

Beverages can also be offered to consumers from beverage dispense systems that can automatically mix and dispense one or more beverages on-demand, i.e., in response to user input such as pushing a button or pressing a lever. Beverage dispense systems can be advantageous because, for example, they can have smaller footprints than retailer refrigerators and can reduce the consumption of bottles (e.g., plastic).

But some beverage dispense systems can include sophisticated machinery, which can be expensive to manufacture and to maintain. Some beverage dispense systems can also be energy intensive, which can be costly to operate and can inhibit their use in localities with unreliable and/or unaffordable power. Some beverage dispense systems can also rely on local water supplies for mixing the beverage and/or for cleaning the beverage dispense systems, which can compromise beverage quality.

Embodiments discussed herein are directed to beverage dispense systems that can automatically mix and dispense one or more beverages on-demand with a limited number of moving parts, which can lower costs associated with manufacturing and producing the beverage dispense systems. The beverage dispense system can include a transparent beverage container, which can allow consumers to view the beverage mixing process to promote consumer engagement. The beverage dispense system can supply beverage ingredients (e.g., water, carbon dioxide, and syrup) in a closed loop manner to improve beverage quality. The beverage dispense systems can include a cooler with an insulated compartment containing a passive heat sink (e.g., ice). Beverage dispense systems with such coolers can provide chilled beverages in localities with unreliable and/or unaffordable power. Structures of the beverage dispense system, such as beverage ingredient containers, supply lines, fittings, the cooler, etc., can be highly accessible, which can facilitate cleaning, replenishment, and/or replacement of such structures.

As discussed above, the beverage dispense system can supply beverage ingredients in a closed loop manner. That is, for beverage quality structures that come in contact with beverage ingredients, such as the beverage container, ingredient containers (e.g., liquid container, gas container, flavoring container), supply lines, etc., can be kept separate from other structures of the beverage dispense system that do not come in contact with beverage ingredients, such as electromechanical components.

The beverage container can contain the beverage ingredients while the beverage ingredients are mixed to form the beverage. Since the beverage container can be transparent, consumers can view the beverage mixing process to promote consumer engagement with the beverage dispense system. The beverage container can be fluidly connected to the ingredient containers and can selectively receive ingredients from the ingredient containers. In embodiments, the beverage dispense system can include a single beverage container for a single beverage. Alternatively, the beverage dispense system can include two or more beverage containers for two or more beverages. In embodiments, beverage container can be tube-shaped and can have two caps disposed respectively at a top and a bottom of the tube-shape. Beverage container can be airtight and can include an outlet, which may include a valve (e.g. manual or solenoid) at the bottom for dispensing beverage.

Embodiments of the beverage dispense system can include a liquid container that can supply a liquid, such as water, to the beverage container. The terms liquid and water can be used interchangeably throughout this description. Further, in embodiments the terms liquid or water can encompass water or other consumable liquids such as milk, juice, alcohol, etc. The liquid container can be a sealed, pressurized container such as a keg. The liquid container can be filled with water under the direction of the beverage producer to improve the quality of the beverage. The liquid container can be interchangeable to facilitate replenishment and/or servicing of the beverage dispense system. Further, because the liquid container can be pressurized water can flow through the beverage dispense system without active pumping. The liquid container can be fluidly connected to a gas container, which can pressurize the liquid container. Additionally or alternatively, the beverage dispense system can include a pump that can pump the water throughout the beverage dispense system.

Embodiments of the beverage dispense system can include a flavoring container that can supply a flavoring, such as syrup, to the beverage container. The terms flavoring and syrup can be used interchangeably throughout this description. Further, in embodiments the terms flavoring or syrup can encompass any substance (with or without flavor) that can be added to the liquid for a given beverage including syrups, concentrates, vitamins, proteins, nutrients, etc. The flavoring container can be a sealed, pressurized container such as a bottle. The flavoring container can be filled with flavoring under the direction of the beverage producer to improve the quality of the beverage. The flavoring container can be interchangeable to facilitate replenishment and/or servicing of the beverage dispense system. Further, because the flavoring container can be pressurized flavoring can flow through the beverage dispense system without active pumping. The flavoring container can be fluidly connected to the gas container, which can pressurize the flavoring container. Additionally or alternatively, the beverage dispense system can include a pump that can pump the flavoring throughout the beverage dispense system.

As discussed above, embodiments of the beverage dispense system can include a gas container that can supply a gas, such as carbon dioxide, to the beverage dispense system. The terms gas and carbon dioxide can be used interchangeably throughout this description. Further, in embodiments the terms gas or carbon dioxide can encompass any consumable gas that can be added to the liquid for a given beverage including, for example, nitrogen. The gas container can be a sealed, pressurized container such as a tank. The gas container can be filled with gas under the direction of the beverage producer to improve the quality of the beverage. The gas container can be interchangeable to facilitate replenishment and/or servicing of the beverage dispense system. Further, because the gas container can be pressurized, gas can flow through the beverage dispense system without active compression. The gas container can include a regulator to regulate the pressure of the gas expelled from the gas container. The same gas container with the regulator can be fluidly connected to the liquid container, the flavoring container, and/or the beverage container and can supply the gas to the liquid container, the flavoring container, and/or the beverage container at the same regulated pressure. This can simplify production and maintenance of the beverage dispense system and can reduce the costs of the beverage dispense system.

Embodiments of the beverage dispense system can include a cooler that can cool the water from the liquid container. The cooler can, for example, be an insulated container with an insulated lid that contains a passive heatsink, such as ice. The insulated lid can be opened and ice can be loaded into the insulated container. The insulated lid can be closed after the ice is loaded and can seal the insulated container to limit heat transfer with the environment surrounding the insulated container. A liquid supply line, which can include a stainless steel coil, can be disposed in a bottom of the insulated container below the ice to cool water that flows through the liquid supply line. The liquid supply line can have a surface area exposed to the interior of the insulated container of a magnitude sufficient for the ice to cool the water to less than 4° C.

Embodiments of the beverage dispense system can include a housing. Housing can hold various structures of the beverage dispense system including, for example, the beverage container, gas container, flavoring container, cooler, a controller, a drip tray etc. Structures within the housing can be arranged in an accessible manner so that the structures can be easily serviced, replenished, replaced, etc. Housing can include cutouts so that ingredient levels, for example in a transparent flavoring container, can be visually observed and monitored. Housing can also include indicia, such as logos, trademarks, etc., to indicate for example the type of beverages available and/or to indicate the identity of the beverage producer.

Embodiments of the beverage dispense system can include a controller that can automatically control the beverage mixing in response to user input. The controller can automatically control the beverage mixing using time-based logic the opens and closes valves of the beverage dispense system in a particular order for a particular period of time. For example, a user can initiate the automatic mixing of the beverage by pushing a button. After the user pushes the button, the controller can open a valve fit to the liquid supply line to supply water from the pressurized liquid container, which can be chilled by the cooler between the liquid container and the beverage container. The controller can open the valve fit to the liquid supply line for a period of time, based on a flowrate of the water, to control the amount of water supplied to the beverage container (e.g., to about two-thirds capacity of the beverage container).

Once the controlled amount of water is supplied to the beverage container, the controller can close the valve fit to the liquid supply line to stop flow of the water to the beverage container. The controller can then open a valve fit to a gas supply line to supply carbon dioxide to the beverage container from the regulated gas container at the regulated pressure. As the carbon dioxide passes through the water in the beverage container, the controller can open a valve fit to a flavoring supply line to supply the flavoring to the beverage container from the pressurized flavoring container. The controller can open the valve fit to the flavoring supply line for a period of time, based on a flowrate of the flavoring, to control the amount of flavoring added to the water in the beverage container (e.g., to a 1:5 flavoring to water ratio). After the controlled amount of flavoring is supplied to the beverage container, the controller can close the valve fit to the flavoring supply line. The controller can close the valve fit to the gas supply line, for example after the valve fit to the flavoring supply line is closed, to terminate the flow of carbon dioxide to the beverage container. The controller can close the valve fit to the gas supply line after a period of time, based on a flowrate of the carbon dioxide, to control the amount of carbon dioxide supplied to the beverage container. The beverage can then be dispensed from the outlet of the beverage container, for example, by opening a valve manually or automatically via the controller.

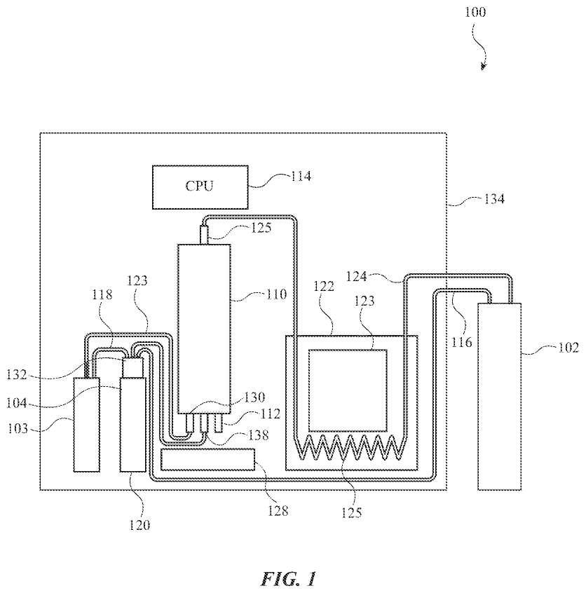

These and other embodiments are discussed below with reference to FIGS. 1-10. Those skilled in the art will readily appreciate that the detailed description given herein with respect to these figures is for explanatory purposes only and should not be construed as limiting. Unless expressly indicated to the contrary or clear from context, the features of and relationships between like structures of any disclosed beverage dispense systems can apply to any other disclosed beverage dispense systems.

FIG. 1 shows a schematic view of an example beverage dispense system 100 that can automatically mix a beverage in response to a user input, such as for example pushing a button. Beverage dispense system 100 can include a liquid container 102 (e.g., a keg with, for example, a 10 L or 20 L capacity) that can contain a liquid, such as water. Beverage dispense system 100 can include a gas container 104 (e.g., a 60 L tank) that can contain a gas, such as carbon dioxide, and can include a regulator 106 that can regulate flow of the gas from the gas container such that the gas is supplied from the regulator at a pressure. Beverage dispense system 100 can include a flavoring container 108 (e.g., a 0.5 L bottle) configured to contain a flavoring, such as syrup. Beverage dispense system 100 can include a beverage container 110 selectively in fluid communication with liquid container 102, gas container 104, and flavoring container 108. Beverage container 110 can be air tight and can receive the liquid, gas, and flavoring respectively from liquid container 102, gas container 104, and flavoring container 108 to form the beverage. In embodiments, beverage container 110 can comprises a transparent material that allows a user to observe mixing of the liquid, gas, and flavoring into the beverage within beverage container 110. This can allow consumers to view the beverage mixing process to promote consumer engagement with the beverage dispense system 100. In embodiments, beverage container 110 can be tube-shaped and can have two caps disposed respectively at a top and a bottom of the tube-shape. Beverage dispense system 100 can include an outlet 112 that can selectively dispense the beverage from the beverage container 110. Beverage dispense system 100 can include a controller 114 that can automatically control flow of the liquid, the gas, and the flavoring to beverage container 110 in response to the user input to mix the liquid, gas, and flavoring into the beverage.

Regulator 106 can be fluidly connected to each of liquid container 102, flavoring container 108, and beverage container 110 and can regulate the pressure of the gas from gas container 104 supplied to liquid container 102, flavoring container 108, and/or beverage container 110. Regulator 106 can simplify the operation of beverage dispense system 100 by performing multiple functions, which can reduce the number of moving parts in beverage dispense system 100 and lower costs associated with manufacturing and maintenance. For example, regulator 106 can be fluidly connected to liquid container 102 via a first gas supply line 116, to flavoring container 108 via a second gas supply line 118, and to beverage container 110 via a third gas supply line 120. By suppling gas to liquid container 102 and/or flavoring container 108 at pressure, regulator 106 can pressurize liquid container 102 and/or flavoring container 108 to promote flow of the respective liquid and/or flavoring to beverage container 110. By supplying gas to beverage container 110 at a regulated pressure, regulator 106 can supply gas at a regular flowrate and controller 114 can use the regular flow rate to supply a controlled amount of gas, as discussed below.

In embodiments, regulator 106 can regulate the pressure of gas supplied to liquid container 102 without intervening control of the gas between regulator 106 and liquid container 102. Additionally or alternatively, regulator 106 can regulate the pressure of gas supplied to flavoring container 108 without intervening control of the gas between regulator 106 and flavoring container 108. This can simplify the beverage dispense system 100 by limiting the number of moving parts.

In embodiments, beverage dispense system 100 can include a cooler 122 that can cool liquid supplied to beverage container 110. For example, cooler 122 can be interposed between liquid container 102 and beverage container 110 to cool the liquid that flows from liquid container 102 to beverage container 110 to a temperature. Cooler 122 can be an insulated compartment and can have an insulated lid that provides access to an interior of the insulated compartment. Beverage dispense system 100 can include a liquid supply line 124 that supplies liquid from liquid container 102 to beverage container 110. Liquid supply line 124 can extend through the insulated compartment of cooler 122 and liquid flowing through liquid supply line 124 can exchange heat through liquid supply line 124 to the cooler 122 to cool the liquid. In embodiments, cooler 122 can include a passive heat sink 123 that does not directly consume power, which can help beverage dispense system 100 offer chilled beverages in localities with unreliable and/or unaffordable power. Passive heat sink 123 can be, for example, ice or other cold material. Additionally or alternatively, passive heat sink 123 can include a plate (e.g., of metal) that can promote even heat transfer between liquid supply line 124 and passive heat sink 123.

Cooler 122 can cool liquid entering the cooler 122 at a first temperature to a second temperature as the fluid exits cooler 122. The first temperature can be for example between 28° C. and 35° C. and the second temperature can be for example less than 4° C. In embodiments, the liquid can be water that can flow through liquid supply line 124 at known flowrate. Liquid supply line 124 can have a surface area 125 (e.g., including a coil shaped portion of liquid supply line 124) exposed to the interior of the insulated compartment. Surface area 125 can be of a magnitude sufficient to transfer heat from the water to the passive heat sink (e.g., ice) to cool the water that enters cooler 122 from fluid container 102 at the first temperature and at the flowrate to the second temperature as the water exits the cooler 122 on its way to beverage container 110. In embodiments, liquid supply line 124 can have insulation between exit of cooler 122 and beverage container 110 reduce heat transfer between the liquid in the liquid supply line 124 and the environment to keep liquid cool.

Beverage dispense system 100 can include one or more fittings that fluidly connect various structures. For example, beverage dispense system 100 can include a first fitting 126 that fluidly connects liquid supply line 124 to beverage container 110 so that liquid can flow from liquid supply line 124 into beverage container 110. First fitting 126 can be provided at a top or a bottom of container 110. Beverage dispense system 100 can include a second fitting 128 that fluidly connects third gas supply line 120 to beverage container 110 so that gas can flow from third gas supply line 120 to beverage container 110. Second fitting 128 can be provided at a top or a bottom of beverage container 110. In embodiments, second fitting 128 is provided at a top of beverage container 110 and an extension line is provided from the top to the bottom of beverage container 110 such that gas is supplied from the bottom of beverage container 110. Suppling gas at the bottom of beverage container 110 (e.g., with second fitting 128 at the bottom of beverage container 110 or via an extension line) can promote, for example, carbonization of beverage by increasing the exposure of the gas to the liquid in beverage container 110. Beverage dispense system 100 can include a third fitting 130 that fluidly connects a flavoring supply line 132 to beverage container 110 so that flavoring can flow from flavoring supply line 132 to beverage container 110. Third fitting 130 can be provided at a top or a bottom of beverage container 110.

In embodiments, third fitting 130 is provided at a bottom of beverage container 110. Alternatively, third fitting 130 can be provided at a top of beverage container 110 and an extension line can be provided from the top to the bottom of beverage container 110 such that flavoring is supplied from the bottom of beverage container 110. Suppling flavoring at the bottom of beverage container 110 (e.g., with third fitting 130 at the bottom of beverage container 110 or via an extension line) can promote, for example, mixing of the beverage by increasing the exposure of the flavoring to the liquid in beverage container 110. Flavoring supply line 132 can be fluidly connected to flavoring container 108 and can supply flavoring from flavoring container 108 to beverage container 110.

Any or all of first, second, and third fittings 126, 128, 130 can respectively include first, second, and third valves that selectively open and close openings within the respective first, second, and third fittings 126, 128, 130 to selectively control flow of fluid to beverage container 110. For example, first fitting 126 can include a first valve interposed between fluid container 102 and beverage container 110, which is configured to selectively control flow of liquid from fluid container 102 to beverage container 110. Second fitting 128 can include a second valve interposed between gas container 104 and beverage container 110, which is configured to selectively control flow of gas from gas container 104 to beverage container 110. Third fitting 130 can include a third valve interposed between flavoring container 108 and beverage container 110, which is configured to selectively control flow of flavoring from flavoring container 108 to beverage container 110. Controller 114 can be operatively connected to any of the valves of the first, second, and third fittings 126, 128, 130 and can selectively open and close any of the valves in response to user input to automatically mix the beverage in beverage container 110.

In embodiments, outlet 112 can include a fourth valve that can selectively open and close to dispense beverage from beverage container 110. The fourth valve can be operatively connected to controller 114 and controller 114 can automatically open the fourth valve to dispense the beverage after the liquid, gas, and flavoring are mixed into the beverage in beverage container 110. Additionally or alternatively, fourth valve can be manually opened (e.g., with a lever) by the user to manually dispense beverage from beverage container 110.

Structures of the beverage dispense system 100 can be housed together in a housing 134. Housing 134 can house, for example, any or all of beverage container 110, gas container 104, flavoring container 108, cooler 122, controller 114, a drip tray 136 located below outlet 112 for collecting beverage that drips from outlet 112, outlet 112, first, second, and third fittings 126, 128, 130, liquid supply line 124, regulator 106, first gas supply line 116, second gas supply line 118, third gas supply line 120, flavoring gas supply line 132, among others. Structures of beverage dispense system 110 housed in housing 134 can be arranged in an accessible manner so that the structures can be easily serviced, replenished, replaced, etc. Housing 134 can also include indicia, such as logos, trademarks, etc., to indicate for example the type of beverages available and/or to indicate the identity of the beverage producer.

In embodiments, any or all structures of beverage dispense system 100 that come in contact with beverage ingredients can include smooth inner surfaces that can be easily cleaned. Additionally or alternatively, any or all structures of beverage dispense system 100 that come in contact with beverage ingredients can be flushed for cleaning periodically with, e.g., water and/or carbon dioxide. Additionally or alternatively, any or all structures of beverage dispense system 100 that come in contact with beverage ingredients between containers (i.e., fluid container 102, gas container 104, flavoring container 108, and beverage container 110) and outlet 112 can be provided in a closed loop that is sealed from the external environment to prevent unwanted substances from mixing with and/or contaminating the beverage.

In embodiments, any or all of liquid container 102, gas container 104, and flavoring container 108 can be refillable and/or replaceable by a beverage producer. Accordingly, beverage producer can maintain control over beverage ingredients and beverage dispense system 100 can produce high quality beverages.

In embodiments, beverage dispense system 100 can include a single beverage container 110 and a single flavoring container 108 for producing a single beverage. Alternatively, beverage dispense system 100 can include more than one beverage container 110 respectively associated with a flavoring container 108 for producing multiple beverages one in each respective beverage container 100. For example, beverage dispense system 100 can include two beverage containers 110 and two flavoring containers 108, each beverage container 110 being associated with one of the two flavoring containers 108 such that beverage dispense system 100 can dispense multiple beverages, one from each beverage container 110.

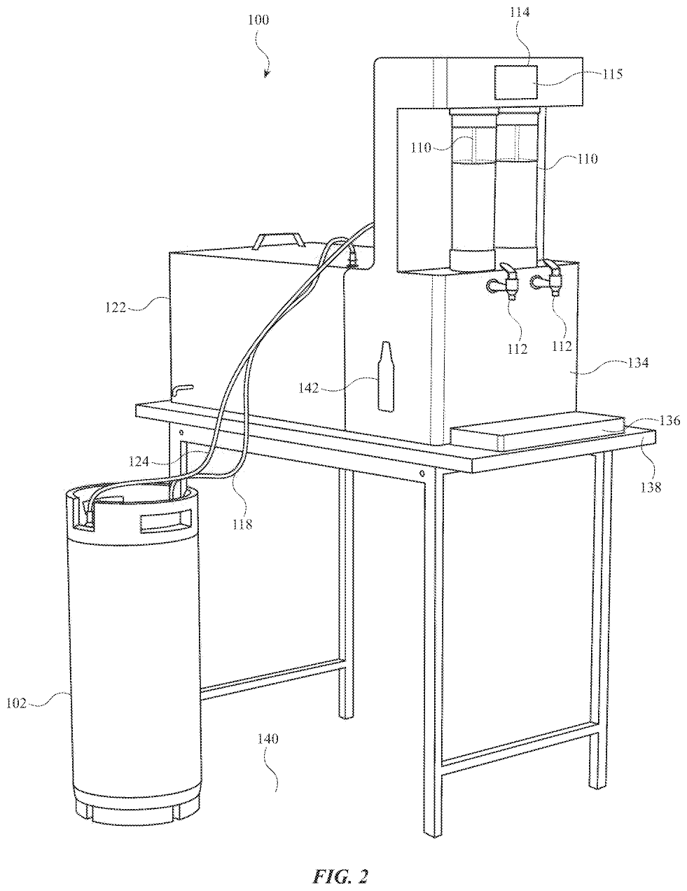

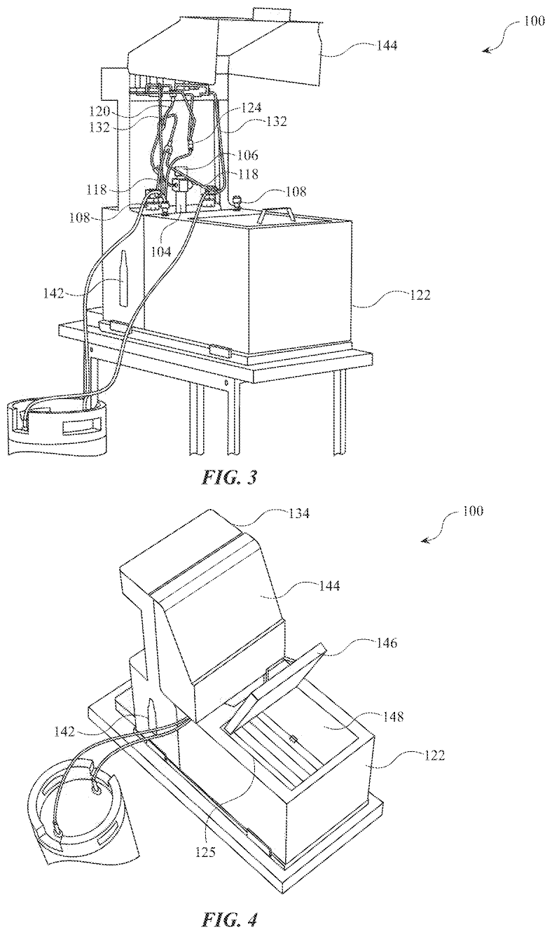

FIGS. 2-4 show perspective views of the example beverage dispense system 100. In embodiments, housing 134 can be provided on a countertop 138. Liquid supply 102 can be provided on a floor 140 adjacent to countertop 138. Housing can include cutouts 142 so that ingredient levels, for example in a transparent flavoring container 108, can be visually observed and monitored. Housing 134 can include an access panel 144 (e.g., at a rear of housing 134) to provide access to structures of beverage dispense system 100, as shown in FIG. 3.

As shown in FIG. 4, cooler 122 can include an insulated lid 146 and an insulated container 148. Insulated lid 146 can seal and selectively provide access to insulated container 148, for example for replenishing insulated container 148 with ice. Surface area 125 of liquid supply line 124 can include a coil shape disposed at a bottom of insulated container 148 to provide an increased surface area relative to a straight supply line.

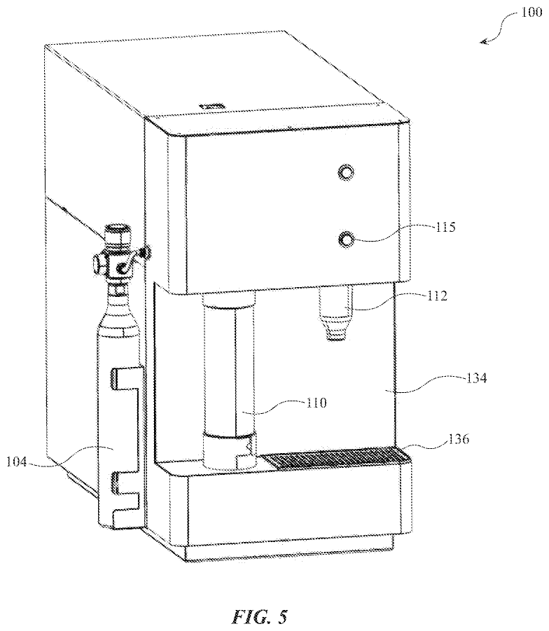

FIG. 5 shows an alternative embodiment of beverage dispense system 100. In this embodiment, a single beverage container 110 is present, with outlet 112 being positioned adjacent to beverage container 100 such that both beverage container 110 and outlet 112 are aligned horizontally. Drip tray 136 is positioned immediately below beverage container 110 and outlet 112 to capture drips from outlet 110. In this embodiment, outlet 112 is the automatic version that does not require user control (e.g., from a lever) to dispense the beverage. As discussed above, controller 114 controls the dispensing of beverage from outlet 112. The remaining elements present in FIG. 5 are identical to the elements discussed above with respect to FIGS. 2-4.

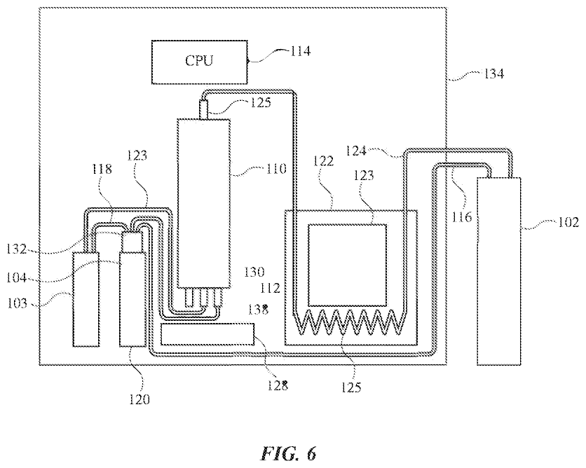

FIGS. 7-11 respectively show steps of an example automatic beverage mixing process using the example beverage dispense system 100. For this example automatic beverage mixing process, the beverage is comprised of water, carbon dioxide, and syrup. But the example automatic beverage mixing process can involve mixing of any fluids, gases, and flavorings discussed herein. The process can begin at a first step, as shown in FIG. 7, at which a user can input a beverage selection into controller 114. For example, controller 114 can include a user interface 115 that can have a button for each beverage that beverage dispense system 100 can automatically mix. The user input can involve pushing the button to initiate automatic mixing of the beverage associated with the button.

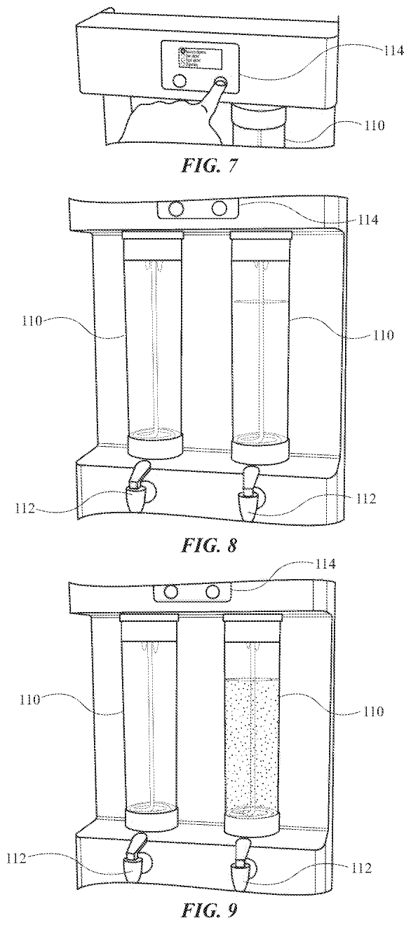

At a second step of the process, as shown in FIG. 8, controller 114 can control the supply of water to beverage container 110. For example, controller 114 can open the first valve in first fitting 126 to control flow of water from liquid container 102 to beverage container 110. Controller 114 can control the amount of water supplied to beverage container 110 by, for example, opening the first valve in first fitting 126 for a first period of time. The first period of time can be set based upon the flowrate of water from liquid container 102 to beverage container 110 such that a controlled amount of water can be supplied to beverage container 110. Controller 114 can cause first valve of first fitting 126 to open for the first period of time and can cause the first valve of the first fitting 126 to close after expiration of the first period of time. Because the first period of time can be set based upon the flowrate of water, controller 114 can control the amount (i.e., to the controlled amount) of water supplied to beverage container 110. In embodiments, first fitting 126 can be disposed at a top of beverage container 110 such that water can be supplied from the top of beverage container 110. Alternatively, first fitting 126 can be disposed at a bottom of beverage container 110 such that the water can be supplied from the bottom of beverage container 110.

At a third step of the process, as shown in FIG. 9, controller 114 can control the supply of carbon dioxide to beverage container 110. For example, controller 114 can open the second valve in second fitting 128 to control flow of carbon dioxide from gas container 104 to beverage container 110. Controller 114 can control the amount of carbon dioxide supplied to beverage container 110 by, for example, opening the second valve in second fitting 128 for a second period of time. The second period of time can be set based upon the flowrate of carbon dioxide from gas container 104 to beverage container 110 such that a controlled amount of carbon dioxide can be supplied to beverage container 110. Controller 114 can cause second valve of second fitting 128 to open for a second period of time and can cause the second valve of the second fitting 128 to close after expiration of the second period of time. Because the second period of time can be set based upon the flowrate of carbon dioxide, controller 114 can control the amount (i.e., to the controlled amount) of carbon dioxide supplied to beverage container 110. In embodiments the second period of time can begin after expiration of the first period of time such that carbon dioxide flows into beverage container 110 after all water has been supplied to beverage container 110, which can improve carbonization of the beverage by increasing the amount of water exposed to the carbon dioxide.

In embodiments, second fitting 128 can be disposed at a bottom of beverage container 110 such that carbon dioxide is dispensed from the bottom of beverage container 110 or an extension line can be provided to supply carbon dioxide at the bottom of the beverage container 110. This arrangement can improve carbonization of the beverage since the carbon dioxide rises through the water from the bottom to the top of beverage container 110 after being supplied to beverage container 110 thereby maximizing the exposure of the carbon dioxide to the water and dissolution therein.

In embodiments, controller 114 can control flow of the gas at the pressure from regulator 106 to beverage container 110, but does not control flow of the gas at the pressure from regulator 106 to liquid container 102. Additionally or alternatively, controller 114 can control flow of the gas at the pressure from regulator 106 to beverage container 110, but does not control flow of the gas at the pressure from regulator 106 to flavoring container 108. Instead, gas flows from regulator 106 to liquid container 102 and/or flavoring container 108 without active control, which can simplify the beverage dispense system 100 by, for example, limiting the number of moving parts.

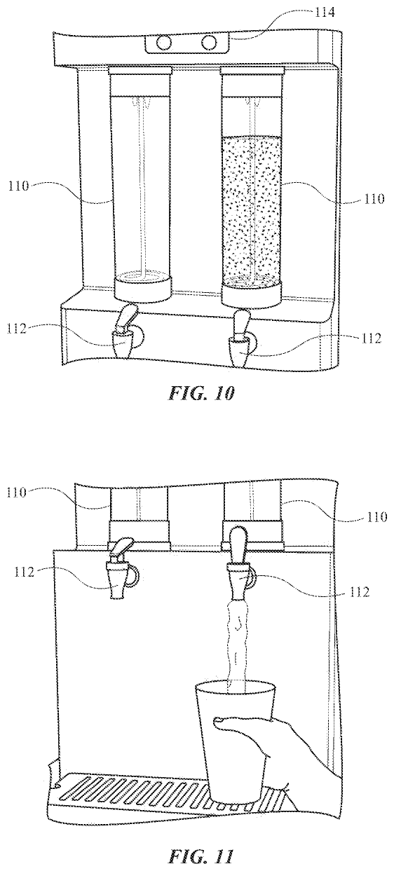

At third step of the process, as shown in FIG. 10, controller 114 can control the supply of the syrup to beverage container 110. For example, controller 114 can open the third valve in third fitting 130 to control flow of syrup from flavoring container 108 to beverage container 110. Controller can control the amount of syrup supplied to beverage container 110 by, for example, opening the third valve in third fitting 130 for a third period of time. The third period of time can be set based upon the flowrate of syrup from flavoring container 108 to beverage container 110 such that a controlled amount of syrup can be supplied to beverage container 110. Controller 114 can cause third valve of third fitting 130 to open for the third period of time and can cause the third valve of the third fitting 130 to close after expiration of the third period of time. Because the third period of time can be set based upon the flowrate of syrup, controller 114 can control the amount (i.e., to the controlled amount) of syrup supplied to beverage container 110. In embodiments, controller 114 can open the third valve of third fitting 130 after expiration of the first period of time and during the second period of time. This arrangement can improve mixing of the syrup in the water since the supply of the carbon dioxide in the water can agitate the water and improve mixing of the syrup during the supply of the syrup.

At a fourth step of the process, as shown in FIG. 11, the mixed beverage can be dispensed from outlet 112 into for example a cup. In embodiments, a user can manually open the fourth valve of outlet 112 using for example a manual lever. Alternatively, controller 114 can automatically open fourth valve of outlet 112 after completion of the mixing of the beverage (e.g. after expiration of the second period of time).

A modified example of an automatic beverage mixing process proceeds in a similar manner as discussed immediately above. However, in this example process, instead of routing flavoring from flavoring container 108 to beverage container 110, the flavoring is routed directly to outlet 112. Controller 114 is configured to synchronize the flow of flavoring to outlet 110 with the flow of the combined liquid and carbon dioxide from beverage container 110. The flavoring and combined liquid and carbon dioxide meet at outlet 112, which is configured to mix the flavoring and carbonated liquid as it is dispensed from outlet 112. FIG. 6 is a schematic diagram showing the modification made to the schematic of FIG. 1 to accommodate this example process. Specifically, as shown in FIG. 6, line 130 is routed directly to nozzle 112, instead of to beverage container 110. Fitting 130 (and corresponding third valve) is also moved to outlet 112. Controller 114 can control the flow of flavoring to outlet 112 in the same manner as it controls the flavoring flow to beverage container 110 in the embodiment discussed above. In some embodiments of this modified process, controller 114 is configured to supply gas to beverage container 110 before it supplied liquid to beverage container 110. In this instance, the first period of time and the second period of time discussed above with respect to opening the first and second valves can be reversed (i.e., the second valve controlling gas flow is opened first, before the first valve controlling liquid flow). This can lengthen the mixing time of the gas and liquid and improve the resulting carbonation of the liquid.

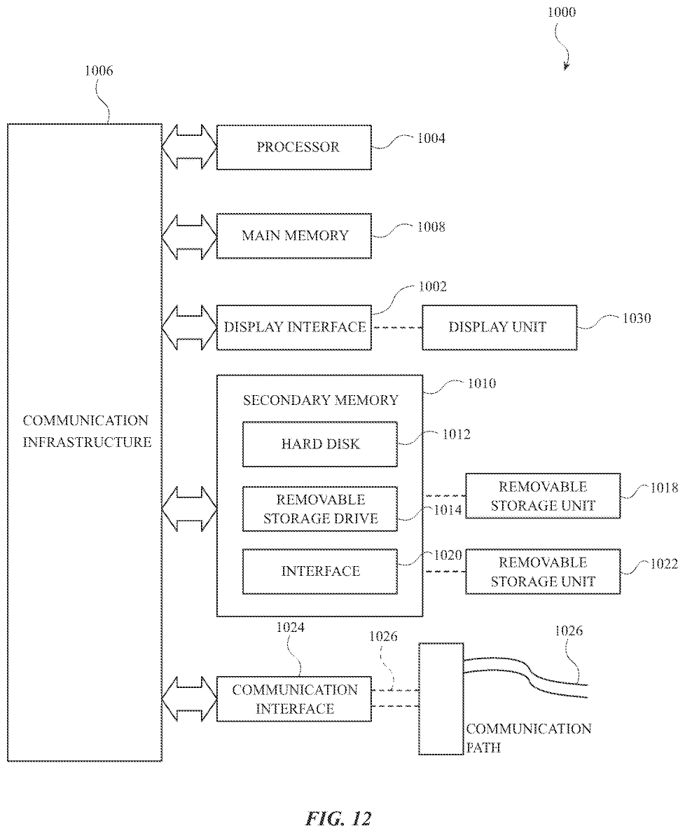

As discussed previously, beverage dispense system 100 can include controller 114. FIG. 12 illustrates an example computer 1000, aspects of which can be incorporated into embodiments of controller 114.

In embodiments, computer 1000 can be implemented as computer-readable code. If programmable logic is used, such logic may execute on a commercially available processing platform or a special purpose device. One of ordinary skill in the art may appreciate that embodiments of the disclosed subject matter can be practiced with various computer configurations, including multi-core multiprocessor systems, minicomputers, and mainframe computers, computer linked or clustered with distributed functions, as well as pervasive or miniature computers that can be embedded into virtually any device.

For instance, at least one processor device and a memory can be used to implement the above described embodiments. A processor device can be a single processor, a plurality of processors, or combinations thereof. Processor devices may have one or more processor “cores.”

Various embodiments of the inventions can be implemented in terms of this example computer 1000. After reading this description, it will become apparent to a person skilled in the relevant art how to implement one or more of the inventions using other computers or computer architectures. Although operations can be described as a sequential process, some of the operations may in fact be performed in parallel, concurrently, or in a distributed environment, and with program code stored locally or remotely for access by single or multi-processor machines. In addition, in some embodiments the order of operations can be rearranged without departing from the spirit of the disclosed subject matter.

Processor 1004 can be a special purpose or a general purpose processor device. As will be appreciated by persons skilled in the relevant art, processor 1004 may also be a single processor in a multi-core/multiprocessor system, such system operating alone, or in a cluster of computing devices operating in a cluster or server farm. Processor 1004 is connected to a communication infrastructure 1006, for example, a bus, message queue, network, or multi-core message-passing scheme.

Computer 1000 can include a main memory 1008, for example, random access memory (RAM), and may also include a secondary memory 1010. Secondary memory 1010 may include, for example, a hard disk drive 1012, or removable storage drive 1014. Removable storage drive 1014 may include a floppy disk drive, a magnetic tape drive, an optical disk drive, a flash memory, a Universal Serial Bus (USB) drive, or the like. The removable storage drive 1014 reads from or writes to a removable storage unit 1018 in a well-known manner. Removable storage unit 1018 may include a floppy disk, magnetic tape, optical disk, etc. which is read by and written to by removable storage drive 1014. As will be appreciated by persons skilled in the relevant art, removable storage unit 1018 includes a computer usable storage medium having stored therein computer software or data.

Computer 1000 may include a display interface 1002 (which can include input and output devices such as keyboards, mice, etc.) that forwards graphics, text, and other data from communication infrastructure 1006 (or from a frame buffer not shown) for display on a display unit 1030.

In implementations, secondary memory 1010 may include other similar means for allowing computer programs or other instructions to be loaded into computer 1000. Such means may include, for example, a removable storage unit 1022 and an interface 1020. Examples of such means may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer 1000.

Computer 1000 may also include a communication interface 1024. Communication interface 1024 allows software and data to be transferred between computer 1000 and other devices, such as communication between control 114 and valves of beverage dispense system 100, or between remote device used to initiate dispensing without directly contacting dispenser. Communication interface 1024 may include a modem, a network interface (such as an Ethernet card), a communication port, a PCMCIA slot and card, or the like. Software and data transferred via communication interface 1024 can be in the form of signals, which can be electronic, electromagnetic, optical, or other signals capable of being received by communication interface 1024. These signals can be provided to communication interface 1024 via a communication path 1026. Communication path 1026 carries signals and can be implemented using wire or cable, fiber optics, a phone line, a cellular phone link, an RF link or other communication channels.

Computer 1000 can include a non-transitory computer readable medium, a computer program medium, a computer usable medium, etc., such as removable storage unit 1018, removable storage unit 1022, and a hard disk installed in hard disk drive 1012. Computer program medium and computer usable medium may also refer to memories, such as main memory 1008 and secondary memory 1010, which can be memory semiconductors (e.g. DRAMs, etc.).

Computer programs (also called computer control logic) or databases are stored in main memory 1008 or secondary memory 1010. Computer programs may also be received via communication interface 1024. Such computer programs, when executed, enable computer 1000 to implement the embodiments as discussed herein. In particular, the computer programs, when executed, enable processor 1004 to implement the processes of the embodiments discussed here. Accordingly, such computer programs represent controllers of computer 1000. Where the embodiments are implemented using software, the software can be stored in a computer program product and loaded into computer 1000 using removable storage drive 1014, interface 1020, and hard disk drive 1012, or communication interface 1024.

Embodiments of the inventions also can be directed to computer program products comprising software stored on any computer useable medium. Such software, when executed in one or more data processing device, causes a data processing device(s) to operate as described herein. Embodiments of the inventions may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

In an embodiment of a beverage dispense system configured to automatically mix a beverage in response to a user input, the beverage dispense system includes a liquid container configured to contain a liquid; a gas container configured to contain a gas;

a flavoring container configured to contain a flavoring; a beverage container selectively in fluid communication with the liquid container and the gas container, the beverage container being configured to receive the liquid and gas respectively from the liquid container and gas container; an outlet fluidly connected to the beverage container and the flavoring container, the outlet configured to selectively dispense the beverage;

a first valve interposed between the fluid container and the beverage container that is configured to selectively control flow of the liquid from the fluid container to the beverage container; a second valve interposed between the gas container and the beverage container that is configured to selectively control flow of the gas from the gas container to the beverage container; a third valve interposed between the flavoring container and the outlet that is configured to selectively control flow of the flavoring from the flavoring container to the outlet; and a controller operatively connected to the first, second, and third valves, the controller comprising a computer having a non-transitory computer readable medium comprising instructions that are executed by the computer in response to the user input to cause the computer to open and close the first, second, and third valves to automatically mix the liquid and gas in the beverage container and to automatically dispense the mix of the liquid and gas and the flavoring through the outlet, wherein the beverage container comprises a transparent material that allows a user to observe mixing of the liquid and gas in the beverage container.

In a further embodiment of a beverage dispense system, the instructions that are executed by the computer in cause the computer to open the second valve for a second period of time to cause the gas to flow from the gas container to the beverage container and close the second valve after expiration of the second period of time.

In a further embodiment of a beverage dispense system, the instructions that are executed by the computer cause the computer to open the first valve, after expiration of the second period of time, for a first period of time to cause the liquid to flow from the liquid container to the beverage container and mix with the gas in the beverage container and close the first valve after expiration of the first period of time.

A further embodiment of a beverage dispense system includes a fourth valve fluidly connected to the beverage container and the outlet and operatively connected to the controller, wherein the instructions cause the computer to open the third valve, after expiration of the first period of time and during the second period of time, for a third period of time to cause the flavoring to flow from the flavoring container to the outlet, and wherein the instructions further cause the computer to open the fourth valve simultaneously with the third valve to allow the mix of gas and liquid in the beverage container to flow to the outlet.

In a further embodiment of a beverage dispense system, the computer comprises a button that provides an interface between the user and the computer and the user input comprises a push of the button.

In a further embodiment of a beverage dispense system, the outlet is configured to mix the liquid and gas from the beverage container with the flavoring from the flavoring container to create the beverage.

It is to be appreciated that the Detailed Description section, and not the Summary and Abstract sections, is intended to be used to interpret the claims. The Summary and Abstract sections may set forth one or more but not all exemplary embodiments of the present invention(s) as contemplated by the inventors, and thus, are not intended to limit the present invention(s) and the appended claims in any way.

The foregoing description of the specific embodiments will so fully reveal the general nature of the invention(s) that others can, by applying knowledge within the skill of the art, readily modify or adapt for various applications such specific embodiments, without undue experimentation, and without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance herein.

References to “an embodiment,” “embodiments,” etc., indicate that the embodiment described may include a particular feature, structure, or characteristic, but every embodiment may not necessarily include the particular feature, structure, or characteristic. Further, when a particular feature, structure, or characteristic is described in connection with an embodiment, it is submitted that it is within the knowledge of one skilled in the art to affect such feature, structure, or characteristic in connection with other embodiments whether or not explicitly described.

The breadth and scope of the present invention(s) should not be limited by any of the above-described exemplary embodiments, but should be defined only in accordance with the following claims and their equivalents.

What is claimed is:

1. A beverage dispense system configured to automatically mix a beverage in response to a user input, the beverage dispense system comprising:
a liquid container configured to contain a liquid;
a gas container configured to contain a gas;
a regulator connected to an opening of the gas container that is configured to regulate flow of the gas from the gas container such that the gas is supplied from the regulator at a pressure,
a flavoring container configured to contain a flavoring;
a beverage container selectively in fluid communication with the liquid container, the gas container, and the flavoring container, the beverage container being configured to receive the liquid, gas, and flavoring respectively from the liquid container, gas container, and flavoring container;
a controller that is configured to automatically control flow of the liquid, the gas, and the flavoring to the beverage container in response to the user input to mix the liquid, gas, and flavoring into the beverage; and
an outlet configured to selectively dispense the beverage,
wherein the regulator is connected to each of the liquid container, the flavoring container, and the beverage container and is configured to regulate the gas from the gas container to each of the liquid container, the flavoring container, and the beverage container at the pressure.

2. The beverage dispense system of claim 1, wherein
the controller controls flow of the gas at the pressure from the regulator to the beverage container but does not control flow of the gas at the pressure from the regulator to the liquid container.

3. The beverage dispense system of claim 1, wherein the regulator is configured to regulate the gas at the pressure supplied to the liquid container without intervening control of the gas between the regulator and the liquid container.

4. The beverage dispense system of claim 1, wherein
the controller controls flow of the gas at the pressure from the regulator to the beverage container but does not control flow of the gas at the pressure from the regulator to the flavoring container.

5. The beverage dispense system of claim 1, wherein the regulator is configured to supply the gas at the pressure to the flavoring container without intervening control of the gas between the regulator and the flavoring container.

6. The beverage dispense system of claim 1, wherein the beverage container comprises a transparent material that allows a user to observe mixing of the liquid, gas, and flavoring into the beverage.

7. A beverage dispense system configured to automatically mix a beverage in response to a user input, the beverage dispense system comprising:
a liquid container configured to contain a liquid;
a gas container configured to contain a gas;
a flavoring container configured to contain a flavoring;
an outlet configured to selectively dispense the beverage;
a beverage container selectively in fluid communication with the liquid container and the gas container, the beverage container being configured to receive the liquid and gas respectively from the liquid container and the gas container;
an outlet fluidly connected to the beverage container and to the flavoring container, the outlet configured to selectively dispense the beverage;
a controller that is configured to automatically control flow of the liquid and the gas to the beverage container and to automatically control the flow of the combined gas and liquid from the beverage container and the flow of the flavoring from the flavoring container to the outlet in response to the user input to mix the liquid, gas, and flavoring into the beverage.

8. The beverage dispense system of claim 7, further comprising a cooler interposed between the liquid container and the beverage container, wherein the cooler comprises a passive heat sink that does not directly consume power and that is configured to cool the liquid that flows from the liquid container to the beverage container to a temperature.

9. The beverage dispense system of claim 8, wherein the cooler comprises an insulated compartment with an insulated lid that provides access to an interior of the insulated compartment.

10. The beverage dispense system of claim 9, further comprising a supply line connected to the liquid container and the beverage container that extends through the insulated compartment.

11. The beverage dispense system of claim 10, wherein the passive heat sink comprises ice that fills the insulated compartment.

12. The beverage dispense system of claim 11, wherein the passive heatsink further comprises a metal plate that abuts against the supply line.

13. The beverage dispense system of claim 11, wherein
the liquid is water that flows through the supply line at a flowrate, and
the supply line comprises a surface area exposed to the interior of the insulated compartment, the surface area is configured to transfer heat from the water to the ice to cool water that flows at the flowrate that enters the cooler from the fluid container at a first temperature to a second temperature as the water exits the cooler.

14. The beverage dispense system of claim 13, wherein the first temperature is between 28° C. and 35° C. and the second temperature is less than 4° C.

15. A beverage dispense system configured to automatically mix a beverage in response to a user input, the beverage dispense system comprising:
a liquid container configured to contain a liquid;
a gas container configured to contain a gas;
a flavoring container configured to contain a flavoring;
a beverage container selectively in fluid communication with the liquid container, the gas container, and the flavoring container that is configured to receive the liquid, gas, and flavoring respectively from the liquid container, gas container, and flavoring container;
a first valve interposed between the fluid container and the beverage container that is configured to selectively control flow of the liquid from the fluid container to the beverage container;
a second valve interposed between the gas container and the beverage container that is configured to selectively control flow of the gas from the gas container to the beverage container;
a third valve interposed between the flavoring container and the beverage container that is configured to selectively control flow of the flavoring from the flavoring container to the beverage container;
an outlet configured to selectively dispense the beverage; and
a controller operatively connected to the first, second, and third valves, the controller comprising a computer having a non-transitory computer readable medium comprising instructions that are executed by the computer in response to the user input to cause the computer to open and close the first, second, and third valves to automatically mix the beverage in the beverage container,
wherein the beverage container comprises a transparent material that allows a user to observe mixing of the liquid, gas, and flavoring in the beverage container.

16. The beverage dispense system of claim 15, wherein the instructions that are executed by the computer in response to the user input to cause the computer to open and close the first, second, and third valves to automatically mix the beverage in the beverage container cause the computer to open the first valve for a first period of time to cause the liquid to flow from the fluid container to the beverage container and close the first valve after expiration of the first period of time.

17. The beverage dispense system of claim 16, wherein the instructions that are executed by the computer in response to the user input to cause the computer to open and close the first, second, and third valves to automatically mix the beverage in the beverage container cause the computer to open the second valve, after expiration of the first period of time, for a second period of time to cause the gas to flow from the gas container to the beverage container and mix with the liquid in the beverage container and close the second valve after expiration of the second period of time.

18. The beverage dispense system of claim 17, wherein the instructions that are executed by the computer in response to the user input to cause the computer to open and close the first, second, and third valves to automatically mix the beverage in the beverage container cause the computer to open the third valve, after expiration of the first period of time and during the second period of time, for a third period of time to cause the flavoring to flow from the flavoring container to the beverage container and mix with the liquid and the gas in the beverage container to form the beverage and close the third valve after expiration of the third period of time but before expiration of the second period of time.

19. The beverage dispense system of claim 15, wherein the computer comprises a button that provides an interface between the user and the computer and the user input comprises a push of the button.

20. The beverage dispense system of claim 15, wherein the outlet comprises a fourth valve operatively connected to the controller.

21. The beverage dispense system of claim 20, wherein the controller opens the fourth valve after the liquid, gas, and flavoring are mixed into the beverage to dispense the beverage.
